(19) United States
(12) Patent Application Publication
(10) Pub. No.: US 2015/0352741 A1
(43) Pub. Date: Dec. 10, 2015

(54) MULTI-DIE CUT WITH COMMON AXIS

(71) Applicant: TEK INDUSTRIES, INC., Freement, NE (US)

(72) Inventor: Stephen Nabity, Elkhorn, NE (US)

(21) Appl. No.: 14/759,403

(22) PCT Filed: Jan. 8, 2014
(86) PCT No.: PCT/US14/10597

§ 371 Date: Jul. 6, 2015

Related U.S. Application Data
(60) Provisional application No. 61/750,064, filed on Jan. 8, 2013.

(51) Int. Cl. B26F 1/44; B26D 1/00

(52) U.S. Cl. CPC B26F 1/44; B26D 1/0006; B26D 2001/0033

(57) ABSTRACT

A die includes a blade having an edge defining a shape for patterning a sheet of material. The die also includes a cushion surrounding the blade, where the blade edge is positioned within the cushion. The die also includes a support for holding the cutting blade in position and supporting the cushion. The die is configured to be at least partially surrounded by another die.

### CLAIM OF PRIORITY

This application claims the benefit priority to U.S. Provisional Application No. 61/750,064, filed on Jan. 8, 2013, and entitled MULTI-DIE CUT WITH COMMON AXIS, which is incorporated herein by reference in its entirety.

### BACKGROUND

Steel-rule dies can be used to cut sheet metal, plastics, wood, cork, felt, fabrics, paperboard, and so forth. A hardened steel strip, referred to as a steel rule, is generally used as a cutting surface for such dies.

### SUMMARY

A die includes a blade having an edge defining a shape for patterning a sheet of material. The die also includes a cushion surrounding the blade, where the blade edge is positioned within the cushion. The die also includes a support for holding the cutting blade in position and supporting the cushion. The die is configured to be at least partially surrounded by another die.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FTG. 1A is a partial isometric view of a die assembly including multiple dies for die patterning sheets of material in accordance with an example implementation of the present disclosure.

FIG. 1B is an exploded isometric view of the die assembly illustrated in FIG. 1A.

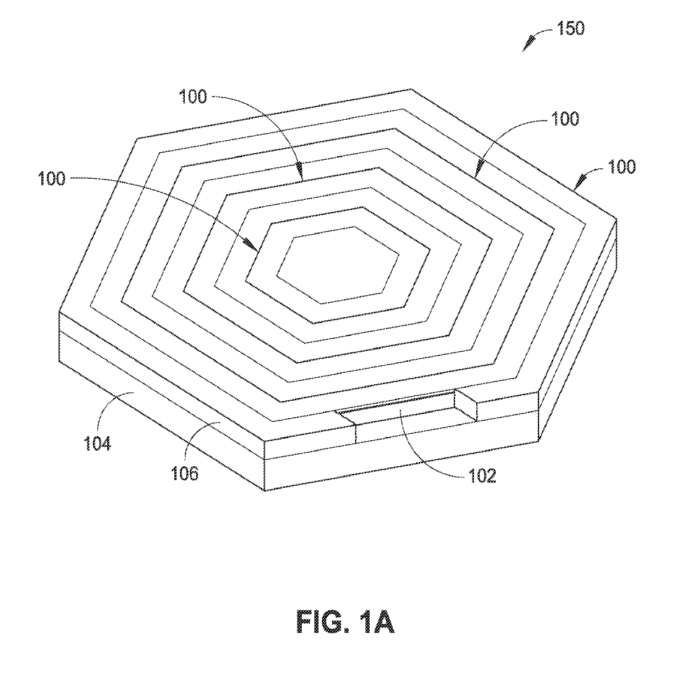

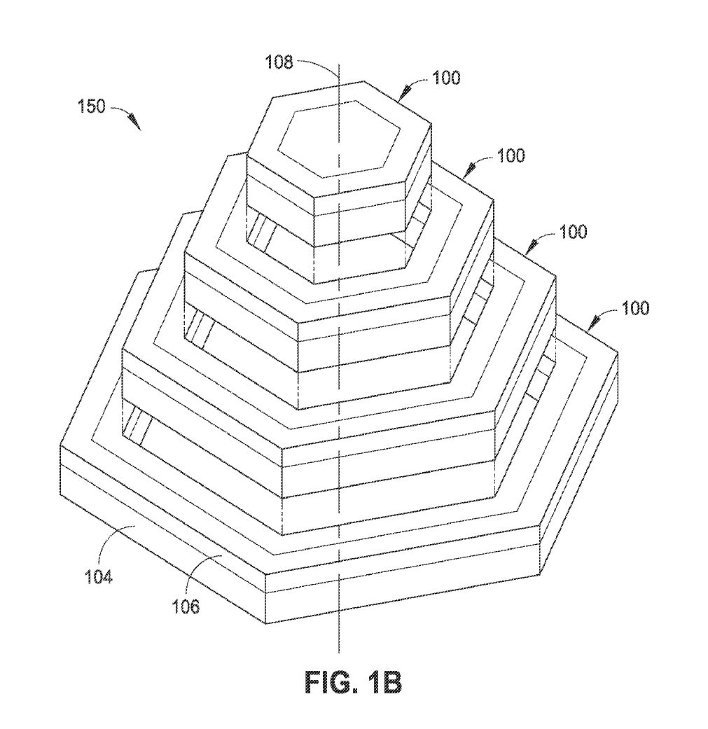

### DETAILED DESCRIPTION

Overview

Dies, such as steel-rule dies, are used for cutting and shaping sheets of materials in various patterns for education, stationery, scrapbooking, and quilting, among other things. Typically, these dies have a steel-rule blade attached to a wooden support. A layer of a cushioning material, such as foam, is generally applied to the support around the blade and used to prevent the blade from being exposed when the die is not in use, such as when positioning material on the die, and when storing or transporting the die.

A tool for patterning sheets of material is described that includes a die assembly having two or more dies, each die including a blade for patterning the material and cushioning material around the blade. The blade and the cushioning material are held in place by a support. The die is configured to be at least partially surrounded by another die.

Example Implementations

A tool comprising a die assembly 150 is described that includes two or more dies 100, each die 100 including a blade 102 held in position by a support 104 and surrounded by a cushion 106. Each die 100 can be implemented as a die board/steel- rule die for die patterning (cutting and/or shaping) one or more sheets of material, such as sheets of paper or paper-like material. For example, a die 100 may be used to pattern sheets of substances made from wood pulp, rags, straw, and other fibrous materials, such as materials used for writing, printing, wrapping, and the like. A die 100 may also be used with other materials including, but not necessarily limited to: plastic, vinyl, cloth, and ceramic substrates. The materials may include printed patterns, images, and the like. Further, the materials may include multiple layers of one or more types of materials, including adhesive layers, silicone/release coating layers, film liners, and the like. However, these materials are provided by way of example only and are not meant to be restrictive of the present disclosure. Thus, other materials may be used with tools in accordance with the present disclosure.

Each die 100 includes one or more blades 102, each blade 102 having an edge defining a shape for patterning a sheet of material. A blade 102 may be a steel-rule blade, such as a sharpened steel blade that is bent and formed to a pattern for die cutting. While a blade 102 may be capable of cutting through sheets of material, it should be noted that a die 100 is not necessarily configured to perform a full cutting operation in all instances. For example, a blade 102 may be designed to impart fold lines, scores, and/or perforations in materials. Additionally, a blade 102 may be configured to partially cut through a material (e.g., cutting through a top layer of a material when forming adhesive stickers or decals). In some implementations, the tool may also comprise a press or a roller die machine. For example, in operation, a die 100 and material to be patterned may be positioned in a press or a roller die machine, and the final shape may be formed by pressing the material into a blade 102. The blade 102 is held in position with a support 104, which may be formed using high density plywood, steel braces, or the like. Support 104 may be constructed such that the blade 102 will retain its shape during operation, storage, and/or transport. For example, a blade 102 may be retained in a channel formed in a piece of high density plywood using a laser cutting process.

The support 104 is also configured to support a cushion 106. The cushion 106 may be formed from a reversibly deformable material, such as a foam material, a rubber material, a foam rubber material, and/or other materials having reversibly deformable structural properties. However, these materials are provided by way of example only and are not meant to be restrictive of the present disclosure. Thus, other cushion materials, such as plastic materials and so forth, can be used. The cushion 106 is configured to surround the blade 102 and support the material placed onto the die 100. For example, the cushion 106 may have a generally planar top surface side (i.e., a side opposite the support 104) that extends up to or beyond the edge of the blade 102. When patterning a material (e.g., using a press or a roller die machine), the material may be pressed into a blade 102 by laying the material across the top surface side of the cushion 106 and pressing down on the material, deforming the cushion 106 and exposing the material to the blade 102. The cushion 106 can define one or more apertures and/or other features providing a registration mark for positioning a sheet of material with respect to the blade 102, such as a geometrical shape indicating, for example, the center of a shape formed by the blade 102.

In embodiments of the disclosure, one or more of the dies 100 can be configured to be at least partially surrounded by another die 100. For example, multiple dies 100 can be inserted into one another along a common axis 108. In this manner, multiple dies 100 can form a die assembly 150. The die assembly 150 can be used to pattern material and form nested shapes one inside another. For example, the die assembly 150 can be used to form nested hexagons cut from a sheet of material, where each hexagon is nested in another hexagon (except for the outermost hexagon). However, hexagon shapes are provided by way of example only and are not meant to be restrictive of the present disclosure. Thus, in other embodiments, various shapes can be used including, but not necessarily limited to: triangles, rectangles (e.g., squares), pentagons, circles, stars, and so forth. Further, different shapes can be nested within one another. For example, a circular shape can be formed within a square shape. It should also be noted that while the accompanying figures illustrate each die 100 inserted into another die including a blade 102, spacers having the same general shape as a die 100 can be used to alter the number of separate shapes created by the cutting action of the blades 102 and/or to alter the width of a shape cut using a die assembly 150.

Conclusion

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A die comprising:
a blade having an edge defining a shape for patterning a sheet of material;
a cushion surrounding the blade; and
a support for holding the cutting blade in position and supporting the cushion, wherein the die is configured to be at least partially surrounded by another die.
